(19) United States
(12) Patent Application Publication
(10) Pub. No.: US 2016/0255356 A1
(43) Pub. Date: Sep. 1, 2016

(54) Evaluation Measure for Images

(71) Applicant: Telefonaktiebolaget L M Ericsson (publ), Stockholm (SE)

(72) Inventors: Jacob Ström, Stockholm (SE); Jonatan Samuelsson, Stockholm (SE)

(21) Appl. No.: 14/759,553

(22) PCT Filed: May 21, 2015
(86) PCT No.: PCT/SE2015/050589

§ 371 Date: Jul. 7, 2015

Related U.S. Application Data
(60) Provisional application No. 62/019,490, filed on Jul. 1, 2014.

(51) Int. Cl. H04N 19/426; G06T 7/40; G06T 7/00; H04N 19/136

(52) U.S. Cl. CPC H04N 19/426; H04N 19/136; G06T 7/408; G06T 7/004

(57) ABSTRACT

Tone mapped versions (11) are created of an image (10) and of a reconstructed image (20) obtained following compression of the image (10) for each tone mapper setting value among a set of multiple such tone mapper setting values. A respective error value is calculated over a non-excluded subset of pixels in the tone mapped versions (11, 21). The non-excluded subset of pixels does not meet at least one exclusion criterion. A mean squared error is calculated as an average for the respective non-excluded subset of pixels in the multiple tone mapped versions (11, 21). An evaluation measure is calculated based on this mean squared error. The evaluation measure is suitable as objective evaluation measure for HDR images and video.

### TECHNICAL FIELD

The present embodiments generally relate to evaluation measures for images, and in particular such an evaluation measure that can be used in connection with encoding and compressing images and video, such as high dynamic range (HDR) images and video.

### BACKGROUND

In the art of regular low dynamic range (LDR) video, also known as standard dynamic range (SDR) video, peak signal-to-noise ratio (PSNR) has been used for long time as an objective evaluation measure to represent the quality of reconstruction of lossy compression codecs. Although not a perfect measure, PSNR has served its purpose well for SDR video.

In the Moving Picture Experts Group (MPEG) ad hoc group on high dynamic range/wide color gamut (HDR/WGC) one of the investigations is aimed at finding an objective evaluation measure for HDR video. The reason being that PSNR works much worse for HDR video than for SDR video. Alternative evaluation measures adapted for HDR video have thereby been brought forward.

An example of such an evaluation measure is known as the ΔE₂₀₀₀ metric [1]. The ΔE2000 metric operates in the L*a*b* color space defined by the International Commission on Illumination (CIE). This color space represents the lightness of the color (L*), its position between red/magenta and green (a*) and its position between yellow and blue (b*). This color space is designed to be perceptually scaled.

Another evaluation metric that has been proposed for HDR images is multi-exposure PSNR (mPSNR) [2]. mPSNR is based on the fact that a HDR image can be constructed using several SDR images taken with different shutter speeds. This process can be reversed by constructing “virtual photographs” of the HDR image, simulating different shutter speeds as shown in FIG. 1.

If the HDR image has been compressed hard, artifacts should be visible in the virtual photographs. A given artifact may not be visible in all of the virtual photographs, but it should be visible in at least one of them. An example is shown in FIG. 2, where color artifacts in the sky are visible in the virtual photograph to the left, whereas block artifacts surrounding the window is visible in the virtual photograph to the right.

The mPSNR metric is based on calculating the mean squared error over all exposures, i.e. all virtual photographs, and over all pixels in the virtual photographs. Finally, the mPSNR metric is calculated as the PSNR of this mean squared error.

The prior art mPSNR approach, though, has shortcomings in terms of giving an impression that the compression of a HDR image is artifact free even though artifacts may be present

Thus, there is still a need for improvements within the field of evaluation measures and in particular for such evaluation measures used for HDR images and video.

### SUMMARY

It is a general objective to provide a suitable evaluation measure for images and video.

It is a particular objective to provide such an evaluation measure suitable for HDR images and video.

These and other objectives are met by embodiments as disclosed herein.

An aspect of the embodiments relates to a method for determining an evaluation measure for an image. The method comprises creating a tone mapped version of the image for each tone mapper setting value among a set of multiple tone mapper setting values. Each tone mapper setting value represents a respective shutter speed. The method also comprises creating a tone mapped version of a version of the image obtained following compression of the image for each tone mapper setting value among the set. The method further comprises calculating, for each tone mapper setting value among the set, an error over a non-excluded subset of pixels in the tone mapped version of the image and in the tone mapped version of the version of the image obtained following compression of the image. The non-excluded subset of pixels does not meet at least one exclusion criterion. The method also comprises calculating a mean squared error as an average error for the respective non-excluded subset of pixels in the multiple tone mapped versions of the image and the multiple tone mapped versions of the version of the image obtained following compression of the image. The method additionally comprises calculating the evaluation measure based on the mean squared error.

Another aspect of the embodiments relates to an encoder for determining an evaluation measure for an image. The encoder is configured to create, for each tone mapper setting value among a set of multiple tone mapper setting values, a tone mapped version of the image. Each tone mapper setting value represents a respective shutter speed. The encoder is also configured to create, for each tone mapper setting value among the set of multiple tone mapper setting values, a tone mapped version of a version of the image obtained following compression of the image. The encoder is further configured to calculate, for each tone mapper setting value among the set of multiple tone mapper setting values, an error over a non-excluded subset of pixels in the tone mapped version of the image and the tone mapped version of the version of the image obtained following compression of the image. The non-excluded subset of pixels does not meet at least one exclusion criterion. The encoder is additionally configured to calculate a mean squared error as an average error for the respective non-excluded subset of pixels in the multiple tone mapped versions of the image and the multiple tone mapped versions of the version of the image obtained following compression of the image. The encoder is also configured to calculate the evaluation measure based on the mean squared error.

A further aspect of the embodiments relates to an encoder for determining an evaluation measure for an image with function modules. The encoder comprises a tone map creator for creating, for each tone mapper setting value among a set of multiple tone mapper setting values, a tone mapped version of the image and a tone mapped version of a version of the image obtained following compression of the image. Each tone mapper setting value represents a respective shutter speed. The encoder also comprises an error calculator for calculating, for each tone mapper setting value among the set of multiple tone mapper setting values, an error over a non-excluded subset of pixels in the tone mapped version of the image and the tone mapped version of the version of the image obtained following compression of the image. The non-excluded subset of pixels does not meet at least one exclusion criterion. The encoder also comprises a mean squared error calculator for calculating a mean squared error as an average error for the respective non-excluded subset of pixels in the multiple tone mapped versions of the image and the tone mapped versions of the version of the image obtained following compression of the image. The encoder additionally comprises an evaluation measure calculator for calculation the evaluation measure based on the mean squared error.

Yet another aspect of the embodiments relates to a computer program comprising instructions, which when executed by a processor, cause the processor to create, for each tone mapper setting value representing among a set of multiple tone mapper setting values, a tone mapped version of the image and a tone mapped version of a version of the image obtained following compression of the image. Each tone mapper setting value represents a respective shutter speed. The processor is also caused to calculate, for each tone mapper setting value among the set of multiple tone mapper setting values, an error over a non-excluded subset of pixels in the tone mapped version of the image and the tone mapped version of the version of the image obtained following compression of the image. The non-excluded subset of pixels does not meet at least one exclusion criterion. The processor is further configured to calculate a mean squared error as an average error for the respective non-excluded subset of pixels in the multiple tone mapped versions of the image and the multiple tone mapped versions of the version of the image obtained following compression of image. The processor is additionally configured to calculate the evaluation measure based on the mean squared error.

A related aspect of the embodiments defines a carrier comprising a computer program as defined above. The carrier is one of an electronic signal, an optical signal, an electromagnetic signal, a magnetic signal, an electric signal, a radio signal, a microwave signal, or a computer-readable storage medium.

The present embodiments provide an efficient objective evaluation measure that can be used for HDR images and video. The evaluation measure is in particular suitable for usage in connection with compressing or encoding such HDR images or video.

### BRIEF DESCRIPTION OF THE DRAWINGS

The embodiments, together with further objects and advantages thereof, may best be understood by making reference to the following description taken together with the accompanying drawings, in which:

FIG. 1 schematically illustrates creating SDR images (virtual photographs) from an HDR image using tone mapping;

FIG. 2 illustrates that different artifacts show up in different SDR images (virtual photographs);

FIG. 3 is a flow chart illustrating a method for determining an evaluation measure according to an embodiment;

FIG. 4 is a flow chart illustrating an embodiment of creating tone mapped versions in FIG. 3;

FIG. 5 is a flow chart illustrating additional, optional steps of the method shown in FIG. 3;

FIG. 6 is a flow chart illustrating a method of encoding an image according to an embodiment;

FIG. 7 schematically illustrates creating tone mapped versions (SDR images) of an original image (HDR image) and of a version of the image obtained following compression of the image (reconstructed HDR image);

FIG. 8 is a diagram illustrating PSNR of virtual photograph and percentage of pixels satisfying the condition to be included in the calculations;

FIG. 9 is a schematic block diagram of an encoder according to an embodiment;

FIG. 10 is a schematic block diagram of an encoder according to another embodiment;

FIG. 11 is a schematic block diagram of a user equipment according to an embodiment;

FIG. 12 is a schematic block diagram of an encoder according to a further embodiment; and

FIG. 13 is a schematic block diagram of a device for encoding an image according to an embodiment.

### DETAILED DESCRIPTION

Throughout the drawings, the same reference numbers are used for similar or corresponding elements.

The present embodiments generally relate to evaluation measures for images, and in particular such an evaluation measure that can be used in connection with encoding and compressing images and video, such as high dynamic range (HDR) images and video.

The evaluation measure of the embodiments can thereby be used, for instance, in connection with encoding and compression in order to compare various encoding or compression modes with each other and thereby selecting a most suitable encoding or compression mode for compressing the image or at least a portion thereof. Accordingly, the encoding or compression mode that results in the best result as represented by the evaluation measure of the embodiments is selected to be used when encoding or compressing the image or the at least a portion thereof.

The image, for which an evaluation measure is determined as described herein, is preferably an HDR image. An HDR image generally has a greater dynamic range of luminosity than is possible with SDR images. The aim is to present the human eye with a range of luminance that is more similar to that which, through the visual system, is familiar in everyday life. The human eye adjusts constantly to the broad dynamic changes ubiquitous in our environment. The brain continuously interprets this information so that most of us can see in a wide range of light conditions.

The two primary types of HDR images are computer renderings and images resulting from merging multiple LDR or SDR photographs. HDR images can also be acquired using special image sensors, like an oversampled binary image sensor.

Within graphics LDR or SDR images are typically represented by 8 bits per color component, i.e. 24 bits per pixel (bpp) when using the red, green, blue (RGB) color space. A HDR image may correspondingly be represented by using a 16-bit floating-point number per color component, resulting in 48 bpp when using the RGB color space.

The evaluation measure may be used for evaluation of still images in graphics, preferably HDR still images in graphics. The evaluation measure could also, or alternatively, be used for other types of images, pictures or frames, in particular other types of HDR images, HDR pictures or HDR frames. For instance, the evaluation measure could be used in connection with encoding HDR video in order to select suitable encoding or compression modes for the individual HDR pictures in the HDR video. Accordingly, “image” as used herein could be a still image, such as a still HDR image, or an image of a video sequence, such as a HDR image of a HDR video sequence.

FIG. 3 is a flow chart illustrating a method for determining an evaluation measure for an image. The method comprises performing the steps S1 to S3 for each tone mapper setting value among a set of multiple tone mapper setting values, which is schematically represented by the line L1 in FIG. 3. Each tone mapper setting value represents a respective shutter speed. Step S1 comprises creating a tone mapped version of the image and step S2 comprises creating a tone mapped version of a version of the image obtained following compression of the image. Steps S1 and S2 can be performed in any order or at least partly in parallel. The following step S3 comprises calculating an error over a non-excluded subset of pixels in the tone mapped version of the image and in the tone mapped version of the version of the image obtained following compression of the image. The non-excluded subset of pixels does not meet at least one exclusion criterion. The method then continues to step S4, which comprises calculating a mean squared error (MSE) as an average error for the respective non-excluded subset of pixels in the multiple tone mapped versions of the image and the multiple tone mapped versions of the version of the image obtained following compression of the image. Finally, the evaluation measure is calculated in step S5 based on the mean squared error.

The method of FIG. 3 thereby determines a set of multiple tone mapped versions of the original image in step S1 and a corresponding set of multiple tone mapped versions of the version of the image obtained following compression of the image in step S2. FIG. 7 schematically illustrates the relationship between the original image 10 and the version 20 of the image 10 obtained following compression of the image 10. Thus, an original image 10, preferably an original HDR image 10, is compressed or encoded according to a compression or encoding mode to obtain a compressed image or encoded 10 image. The compressed or encoded image is then decompressed or decoded in order to obtain the version 20 of the image 10 obtained following compression of the image 10, also referred to as a reconstructed image 20 herein.

Generally, the compression or encoding process is lossy implying that the compressed or encoded image is an inexact approximation for representing the image content, i.e. the pixel values, of the original image 10. The reconstructed image 20 obtained by decompression or decoding of the compressed or encoded image is thereby a version or representation of the original image 10 as processed through the compression-decompression/encoding-decoding procedure. Different compression and encoding modes will result in different compressed images and different reconstructed images 20 following decompression or decoding. The evaluation measure can thereby be used in order to select the “best” compression or encoding mode and thereby the “best” compressed or encoded image for the original image 10.

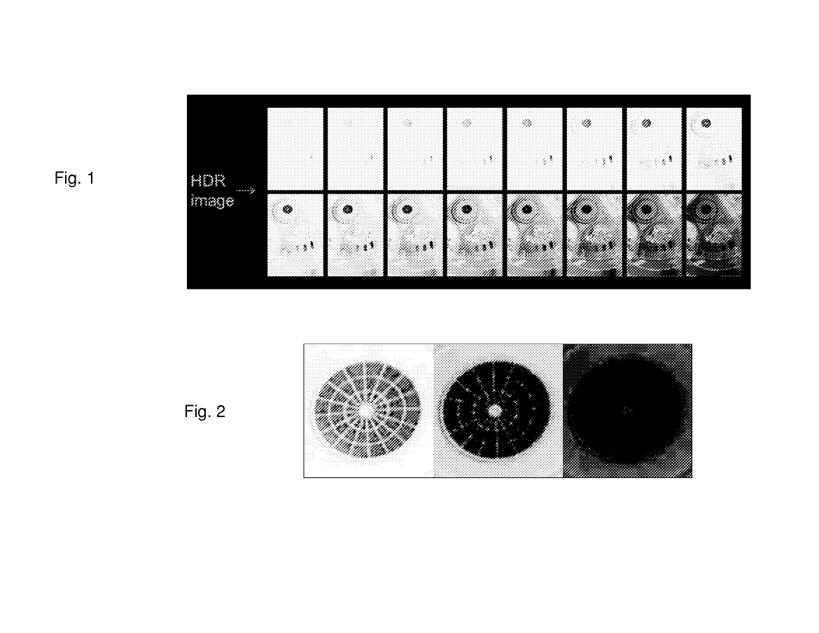

As is shown in FIG. 7, multiple tone mapped versions 11, 21 are created for both the original image 10 and for the reconstructed image 20 in steps S1 and S2 of FIG. 3. This means that for a given original image 10, preferably original HDR image, multiple tone mapped versions 11 of the original image 10 are obtained. Correspondingly, for the reconstructed image 20, preferably the reconstructed HDR image, multiple tone mapped versions 21 of the reconstructed image 20 are obtained. These tone mapped versions 11, 21 are preferably SDR or LDR images 11, 21. This corresponds to the process shown in FIG. 1, where multiple tone mapped versions or virtual photographs or images can be created from a single input HDR image.

Steps S1 to S3 of FIG. 3 are performed for each tone mapper setting value among a set of multiple, i.e. at least two, tone mapper setting values. This means for each such tone mapper setting value among the set a tone mapped version 11 of the original image 10 is created in step S1 and a tone mapped version 21 of the reconstructed image 20 is created in step S2. An error is then calculated in step S3 based on the tone mapped versions created in steps S1 and S2.

Accordingly, if the set consists of N≧2 tone mapper setting values, then N tone mapped versions 11 of the original image 10 and N tone mapped versions 21 of the reconstructed image 20 are created and N errors are calculated.

The error calculated in step S3 is not calculated over all pixels in the tone mapped versions 11, 21 of the original image 10 and the reconstructed image 20. In clear contrast, the error is merely calculated over the so-called non-excluded subset of pixels in the tone mapped version 11 of the original image 10 and the tone mapped version 21 of the reconstructed image 20. The non-excluded subset of pixels does not meet at least one exclusion criterion. This means that any pixels that meet the at least one exclusion criterion do not form part of the non-excluded subset of pixels and are thereby excluded from the error calculation in step S3. Hence, the pixels in the tone mapped versions 11, 21 could be regarded as either belonging to the non-excluded subset of pixels if the pixel does not meet the at least one exclusion criterion or an excluded subset of pixels if the pixel meets at least exclusion.

The creation of tone mapped versions 11, 21 of the original image 10 and of the reconstructed image 20 could be performed according to various embodiments. Basically the process is the reverse of constructing a HDR image from multiple SDR images taken with different shutter speeds. This means that each tone mapped version 11, 21 of the original image 10 or the reconstructed image 20 is associated with a respective tone mapper setting value representing a respective shutter speed.

In the art, a tone mapped version of an image is sometimes denoted virtual photograph. Hence, steps S1 and S2 could be regarded as creating a virtual photograph of the original image 10 (step S1) or of the reconstructed image 20 (step S2). However, the present embodiments are not limited to having photographs as the original image 10 but also works well for other types of images, including computer generated images.

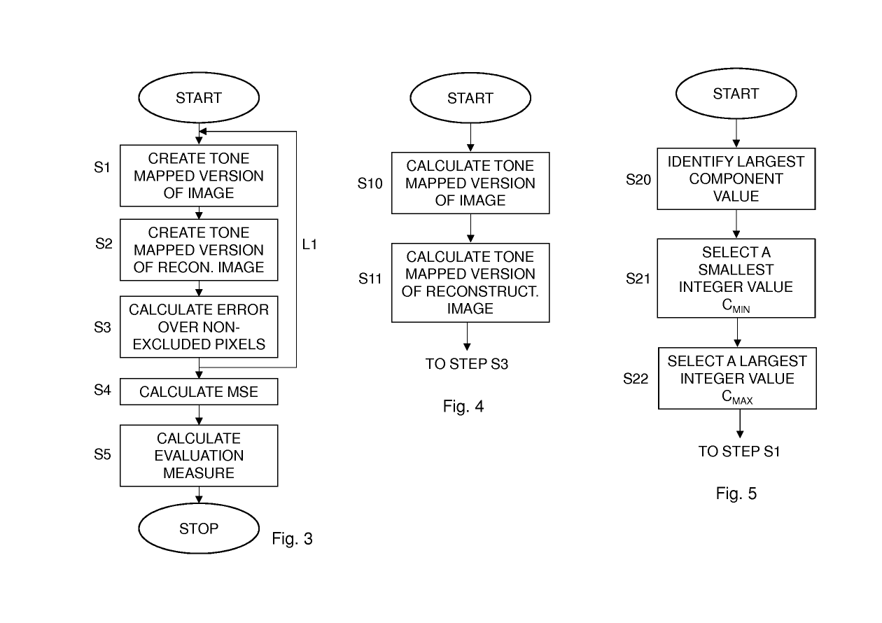

FIG. 4 is a flow chart illustrating a particular embodiment of steps S1 and S2 in FIG. 3. The method starts with step S10, which comprises calculating a tone mapped version 11 of the image 10 (original image 10) as:

R_{LDR}^{c}(x, y)=clamp(0, T, round(T×(2^{c}×R_{HDR}(x, y))^{(1/γ)}))

G_{LDR}^{c}(x, y)=clamp(0, T, round(T×(2^{c}×G_{HDR}(x, y))^{(1/γ)}))

B_{LDR}^{c}(x, y)=clamp(0, T, round(T×(2^{c}×B_{HDR,C}(x, y))^{(1/γ)}))

wherein R_{HDR} (x, y), G_{HDR} (x, y), B_{HDR} (x, y) represent a first, a second and a third pixel component of pixel position (x, y) in the image 10, R_{LDR}^{C} (x, y), G_{LDR}^{C} (x, y), B_{LDR}^{c} (x, y) represent a first, a second and a third pixel component of pixel position (x, y) in the tone mapped version 11 of the image 10, c represents the tone mapper setting value, γ represents a display gamma, T is a saturation value, clamp(0, T , a) is a clamping function outputting 0 if a<0, T if a>T and a if 0≦a<T, and round( )is a rounding function. The method also comprises step S11, which comprises calculating a tone mapped version 21 of the version 20 (reconstructed image 20) of the image 10 obtained following compression of the image 10 as:

R_{LDR,C}^{c}(x, y)=clamp(0, T, round(T×(2^{c}×R_{HDR,C}(x, y))^{(1/γ)}))

G_{LDR,C}^{c}(x, y)=clamp(0, T, round(T×(2^{c}×G_{HDR,C}(x, y))^{(1/γ)}))

B_{LDR,C}^{c}(x, y)=clamp(0, T, round(T×(2^{c}×B_{HDR,C}(x, y))^{(1/γ)}))

wherein R_{HDR,C}(x, y), G_{HDR,C}(x, y), B_{HDR,C}(x, y) represent a first, a second and a third pixel component of pixel position (x, y) in the version 20 of the image 10 obtained following compression of the image 10, and R_{LDR,C}(x, y), G_{LDR,C}^{C}(x, y), B_{LDR,C}^{c}(x, y) represent a first, a second and a third pixel component of pixel position (x, y) in the tone mapped version 21 of the version 20 of the image obtained following compression of the image 10. The method then continues to step S3 in FIG. 3. Steps S10 and S11 can be performed in any order or at least partly in parallel.

The calculations performed in steps S10 and S11 are thereby repeated for each tone mapper setting value among the set. Hence, if the set comprises N such tone mapper setting values then steps S10 and S11 are performed N times using the tone mapper setting value cₙ, wherein n=0 . . . N-1. This means the first time steps S10 and S11 are performed c in the equations above have the value c₀, the second time c=c₁ and so on.

Gamma defines the relationship between a numerical value of a pixel and its actual luminance. Without gamma, representing the luminance as an integer between, say, 0 and 255 could be done using L=100×n/255, where L is the luminance in candela per square meter and n the code value. However, that would give too big relative error for dark values and unnecessary small errors for bright values. As an example, when stepping from n=1 to n=2, the luminance would double from L(1)=100×1/255=0.3921 cd/m² to L(2)=100×2/255=0.7843, a relative difference of (0.7843−0.3921)/0.3921=100%. In the bright areas stepping from n=254 to n=255 would bring about a much lower relative difference, since L(254)=99.60 and L(255)=100, the relative difference becoming (100−99.60)/99.60=0.39%. Since the eye can be more sensitive to the relative error than to the absolute error, representing low dynamic range images using a linear function such as L=100×n/255 is not a good idea. Therefore, a low dynamic range image is instead represented using a gamma function; L=100×(n/255)^{γ}, where γ is a positive value such as 2.2. Now n=20 gives a similar luminance value as n=1 gave before; L(20)=100×20/255)^{2.2}=0.3697 cd/m² which is close to 0.3921 cd/m². But now if we step one step to n=21 we get a luminance of L(21)=100×(21/255)^{2.2}=0.4116. The relative error is now (0.4116−0.3697)/0.3697=11.3% which is much smaller than 100%. This advantage is taken at the expense of the accuracy near 100 cd/m², the last two steps are L(254)=100×(254/255)^{2.2}=99.1393 and L(255)=100×(21/255)^{2.2}=100, which gives a relative error of (100−99.1393)/99.1393=0.87%.

In summary, using gamma when converting an integer number to a luminance lowers the relative error substantially for dark luminances, at the cost of a small increase of the relative error for bright luminances, which is better attuned to how the human visual system perceives low dynamic range images. Therefore low dynamic range images are represented in gamma form and comparisons between two images are also often made between the gamma representations, rather than between the linear luminance values.

The saturation value is a threshold value used to define a maximum value for a pixel component. This saturation value is preferably set to 255 although other threshold values are possible and within the scope of the embodiments. Hence, in an embodiment the saturation value is preferably equal to the maximum value a channel (color component) can have in the SDR images.

The clamping function restricts the value of the round function within the interval of 0 and the saturation value, such as 255. This means that if the output is smaller than 0 or larger than the saturation value then the clamping function outputs 0 or the saturation value.

In the calculations performed in steps S10 to S11, each pixel comprises three pixel components. There are various color spaces available in the art for representing pixel values. An example is the RGB space. In such a case, the first pixel component is a red value (R), the second pixel component is green value (G) and the third pixel component is a blue value (B). Other color spaces use a luminance value together with two chrominance values in order to represent the pixel values. Also such and other color spaces could be used according to the embodiments. Then the first pixel component is the luminance value, the second pixel component is a first chrominance value and the third pixel component is a second chrominance value.

Another example of creating tone mapped versions of images is to use a tone mapper function:

$$PQ ( x ) = {( \frac{{c}_{2} \times {x}^{{m}_{1}} + {c}_{2}}{{c}_{3} \times {x}^{{m}_{1}} + 1} )}^{{m}_{2}}$$

$$where \text{:}$$

$${m}_{1} = \frac{2610}{4 \times 4096}$$

$${m}_{2} = \frac{2523 \times 128}{4096}$$

$${c}_{1} = \frac{3424}{4096}$$

$${c}_{2} = \frac{2413 \times 32}{4096}$$

$${c}_{3} = \frac{2392 \times 32}{4096}$$

In such a case, step S10 preferably comprises calculating a tone mapped version 11 of the original image 10 as:

R_{LDR}^{c}(x, y)=clip(0, 2²−1, floor((2^{N}−1)×PQ(2^{c}×R_{HDR}(x, y))))

G_{LDR}^{c}(x, y)=clip(0, 2^{N}−1, floor((2^{N}−1)×PQ(2^{c}×G_{HDR}(x, y))))

B_{LDR}^{c}(x, y)=clip(0, 2^{N}−1, floor((2^{N}−1)×PQ(2^{c}×G_{HDR}(x, y))))

In this embodiment, the saturation value is 2^{N}−1. The floor function maps a real number to the largest previous integer. More precisely, floor(x)=[x] is the largest integer not greater than x. The clip function is the same as the previously described clamp function, i.e. clip(0, T , a) outputs 0 if a<0, T if a>T and a if 0≦a≦T. In this embodiment, step S11 preferably comprises calculating a tone mapped version 21 of the reconstructed image 20 as:

R_{LDR}^{c}(x, y)=clip(0, 2²−1, floor((2^{N}−1)×PQ(2^{c}×R_{HDR,C}(x, y))))

G_{LDR}^{c}(x, y)=clip(0, 2^{N}−1, floor((2^{N}−1)×PQ(2^{c}×G_{HDR,C}(x, y))))

B_{LDR}^{c}(x, y)=clip(0, 2^{N}−1, floor((2^{N}−1)×PQ(2^{c}×G_{HDR,C}(x, y))))

The above described embodiments should merely be seen as illustrative but non-limiting examples of tone mapping operations that can be used in order to create the tone mapped versions 11, 21. Accordingly, other tone mappers and tone mapper functions that output a tone mapped version of an input image given a tone mapper setting value representing a shutter speed can be used. In particular, any such tone mapping operation or function that outputs N SDR tone mapped version of an input HDR image for N different tone mapper setting values can be used.

In an embodiment, step S3 of FIG. 3 comprises calculating the error representing a difference in pixel values of the tone mapped version 11 of the image 10 and the tone mapped version 21 of the version 20 of the image 10 obtained following compression of the image 10 for the non-excluded subset of pixels.

Hence, in a particular embodiment step S3 comprises calculating ΔR^{c}=R_{LDR}^{c}−R_{LDR,C}^{c}, ΔG^{c}=G_{LDR}^{c}−G_{LDR,C}^{c}, ΔB^{c}=B_{LDR}^{c}−B_{LDR,C}^{c}. This means that, for each pixel position that belongs to the non-excluded subset of pixels, a difference in pixel component values is calculated between the tone mapped version 11 of the original image 10 and the tone mapped version 21 of the reconstructed image 20.

In an embodiment, the at least one exclusion criterion comprises a black pixel and a pixel having at least one pixel component equal to or exceeding a saturation value.

Thus, in preferred embodiment, the at least one exclusion criterion comprises a first exclusion criterion corresponding to a black pixel and a second exclusion criterion corresponding to a pixel having at least one pixel component equal to or exceeding a saturation value.

Generally, a black pixel has the pixel value (0,0,0), i.e. all its pixel components are equal to zero (smallest possible pixel component value). Hence, if a pixel has the pixel value (0,0,0) it meets the first exclusion criterion and is therefore excluded from the calculation performed in step S3 and therefore does not belong to the non-excluded subset of pixels.

The saturation value used in the second exclusion criterion preferably corresponds to the previously mentioned saturation value used in the calculation of the tone mapped versions in steps S10 and S11. Hence, in a particular embodiment the saturation value could be 255. In such a case, if at least one of the pixel component values is equal to or exceeding this saturation value then the pixel meets the second exclusion criterion and is excluded from the calculation performed in step S3 and therefore does not belong to the non-excluded subset of pixels.

In an embodiment, the at least one exclusion criterion is dependent on the pixel values in the original HDR image. For instance, if a pixel in the HDR image is too dark it is excluded. This may be realized as if w_{R}×R_{HDR}+w_{G}×G_{HDR}+w_{B}×B_{HDR}<T_{HDR} then that pixel is excluded, wherein w_{R}, w_{G}, w_{B} are respective weights for the channels and R_{HDR}, G_{HDR}, B_{HDR} represent the pixel values of the pixel in the HDR image. T_{HDR} is a defined threshold value that defines how dark pixels that are allowed to be included in the error calculation.

Generally, the weights are preferably larger than zero. In an example embodiment, w_{R}=0.212639, w_{G}=0.715169, w_{B}=0.072192 and T_{HDR}=0.0 01.

This exclusion criterion may be combined with any or both of the above described exclusion criteria.

In an embodiment, step S3 of FIG. 3 comprises calculating a difference in pixel value of the tone mapped version 11 of the image 10 and the tone mapped version 21 of the version 20 of the image 10 obtained following compression of the image 10 for each pixel position except for pixel positions having a black pixel or having at least one pixel component equal to or exceeding a saturation value in the tone mapped version 11 of the image 10.

Thus, in an embodiment the investigation of whether to include or exclude a pixel in the error calculation in step S3 is preferably performed on the pixels in the tone mapped version 11 of the original image 10 as obtained in step S1 of FIG. 3 or step S10 of FIG. 4. This could be performed by going through all pixel positions, such as from the upper left corner, row-by-row or column-by-column, to the lower right corner, in the tone mapped version 11 of the original image 10 and investigating if the current pixel position is black (has pixel value (0,0,0)) or if the current pixel position has at least one pixel component value equal to or exceeding the saturation value. If any of these exclusion conditions are met that particular pixel position is excluded from the error calculation in step S3. If none of the exclusion conditions are met the particular pixel position belongs to the non-excluded subset of pixels and should be used when calculating the error in step S3. The calculation of the error is then performed for those pixel positions that did not meet any of the exclusion criteria.

In a particular embodiment, the set of multiple tone mapper setting values is [−36, 15]. In another particular embodiment, the set of multiple tone mapper setting values is [−34, 15]. Thus, the set preferably comprises 36 or 34 negative tone mapper setting values (−36 to −1) or (−34 to −1), zero and 15 positive tone mapper setting values (1 to 15) giving a total of 52 or 50 tone mapper setting values. In such a case, steps S1-S3 (or S10, S11 and S3) are performed in total 52 or 50 times. This set of tone mapper setting values is wide enough to guarantee that the entire signal is covered.

The loop over steps S1-S3 or S10, S11 and S3 may, however, in some cases be performed more efficiently, i.e. a reduced number of times as compared to having a fixed set of tone mapper setting values. Hence, in an embodiment, the set of tone mapper setting values could be determined for the particular image to thereby reduce the number of times the loop is performed by omitting tone mapper setting values that result in tone mapped versions of the image in which all pixels meet an exclusion criterion, e.g. are all black or all have at least one pixel component equal to or exceeding the saturation value.

FIG. 5 schematically illustrates such an approach. The method generally starts in step S20, which comprises identifying a largest component value V of the image 10. A next step S21 comprises selecting a smallest integer value cₘᵢₙ of the tone mapper setting in the set of multiple tone mapper setting values so that 2^{c}×V^{(1/γ)}>0. Step S22 comprises selecting a largest integer value cₘₐₓ of the tone mapper setting in the set of multiple tone mapper setting values so that 2^{c}×V^{(1/γ)}<T, wherein T is a saturation value, e.g. 255, and the set of multiple tone mapper setting values is [cₘᵢₙ, cₘ]. Steps S21 and S22 can be performed in any order or at least partly in parallel. The method then continues to step S1 in FIG. 3 of step S10 in FIG. 4. The saturation value is preferably as defined above, e.g. equal to 255.

For most images cₘᵢₙ>−36 or −34 and/or cₘᵢₙ<15, thereby reducing the number of tone mapper setting values in the set as compared to using a fixed set of [−36, 15] or [−34, 15].

In an embodiment, step S4 of FIG. 3 comprises calculating the MSE as:

$$MSE = \frac{1}{{Σ}_{c} ‖ {S}_{c} ‖} {\sum }_{c}^{ } {\sum }_{{S}_{c}}^{ } \frac{1}{3} ( {( Δ {R}^{c} )}^{2} + {( Δ {G}^{c} )}^{2} + {( Δ {B}^{c} )}^{2} )$$

wherein S_{c} represents the non-excluded subset of pixels for the tone mapper setting value c, ∥S_{c}∥ represents the number of pixels in the non-excluded subset of pixels for the tone mapper setting value c, ΔR^{c}=R_{LDR}^{c}−R_{LDR}^{c},ΔG^{c}=G_{LDR}^{c}−G_{LDR,C}^{c}, ΔB^{c}=B_{LDR}^{c}−B_{LDR,C}^{c}, R_{LDR}^{C}(x, y), G_{LDR}^{C}(x, y), B_{LDR}^{c}(x, y) represent a first, a second and a third pixel component of pixel position (x, y) in the tone mapped version 11 of the image 10, and R_{LDR,C}^{C}(x, y), G_{LDR,C}^{C}(x, y), B_{LDR,C}(x, y) represent a first, a second and a third pixel component of pixel position (x, y) in the tone mapped version 21 of the version 20 of the image 10 obtained following compression of the image 10.

In another embodiment, step S4 of FIG. 3 comprises calculating the MSE as:

$$MSE = \frac{1}{{Σ}_{c} ‖ {S}_{c} ‖} {\sum }_{c}^{ } {\sum }_{{S}_{c}}^{ } \frac{1}{3} {w}_{c} ( {( Δ {R}^{c} )}^{2} + {( Δ {G}^{c} )}^{2} + {( Δ {B}^{c} )}^{2} )$$

wherein w_{c} is a non-negative weight defines so that Σ_{c}w_{c}=1. In this embodiment, the error is weighted dependent on the tone mapper setting value c.

The evaluation measure is then calculated based on this MSE in step S5. Hence, in an embodiment the evaluation measure=function(MSE), for some defined function. A particular preferred such function is peak signal-to-noise ratio (PSNR). Hence, in an embodiment, step S5 comprises calculating the evaluation measure as a peak signal-to-noise-ratio of the mean squared error.

In a particular embodiment, the evaluation measure (mPSNR) is calculated a peak signal-to-noise ratio as:

$$mPSNR = 10 \times {log}_{10} ( \frac{{T}^{2}}{MSE} )$$

wherein MSE represents the mean squared error and T represents a saturation value.

The embodiments present the mPSNR measure, which has been used for evaluation of HDR still images in graphics. In short, for each image, the mPSNR evaluation creates several virtual photographs with different virtual shutter speeds, and then regular PSNR is measured on these virtual photographs. The mPSNR value is an aggregate of these PSNR measures. The embodiments also present an adaptation of the measure, wherein averaging over black pixels and over pixels with saturated channels is avoided.

In the prior art, a manual selection of c (tone mapper setting value) was used. According to an embodiment, a sufficiently large range for c is used, i.e. in an embodiment [−36, 15] is used.

According to a further embodiment not all pixels are included in the formula for calculating MSE, but those who either

a) have all components being zero (0,0,0) (black)

b) have one or more components being 255, such as, for instance, a pixel with values (18, 255, 0) are excluded.

$$This is summed up in$$

$$MSE = \frac{1}{Σ ‖ {S}_{c} ‖} {{\sum }_{c}}^{ } {\sum }_{{S}_{c}} \{ {( Δ {R}_{LDR}^{c} )}^{2} + {( Δ {G}_{LDR}^{c} )}^{2} + {( Δ {B}_{LDR}^{c} )}^{2} \} .$$

It should be noted that a pixel with just one or two channels, i.e. pixel components, being zero is allowed, such as (12, 240, 0) or (0, 0, 21).

Further, it is this exclusion of pixels which makes it possible to use a “sufficiently large range” for c. The reason for using these two criteria is that for small values of c (large negative values), most pixels will become black (0,0,0), and therefore the MSE will be small for those pixels. This gives an impression that the compression is artifact free, which is not necessarily the case. In reality, those pixels do not carry any information, and their exclusion thus makes the measure better. Likewise for values that are bigger than 255, most values will become white (255, 255, 255) when c is large enough, and this also give the erroneous impression that the compression is artifact free.

Also, if you have a very large value in one component, and small in the other components, such as (4000, 1, 2), it will be hard for the human eye to tell the difference between this and, say (4000, 2, 2), which might be the compressed result. But with a large enough c-number, (4000, 1, 2) will be mapped to, for instance, (255, 90, 180) whereas the compressed result (4000, 2, 2) will be mapped to (255, 180, 180). This will result in a huge error in the green component, whereas this is likely not visible in the actual pixel. Hence it makes sense to remove this pixel from the calculation, which is done in the proposed method since the red component has saturated to 255.

An alternative is to exclude pixels not when they reach 255 but when they reach another number, say 272, or 384. This would allow pixels to be a contributor to the measure longer when the result is near 255 instead of strictly under 255. This can improve the measure sensitivity to color errors.

According to one aspect of the embodiments, a method in an encoder for encoding a video sequence is provided.

In the encoder, the following steps are performed:

1) Create a tone mapped version of the original and the compressed image (reconstructed image).

2) Exclude some pixels due to an exclusion criterion.

3) Calculate the error over the non-excluded pixels.

4) Do this (1-3 above) over a variety of tone mapper settings from dark to bright.

5) Calculate the MSE as the average error for these non-excluded pixels in all these tone mapped images.

6) Calculate the PSNR from this MSE.

According to an embodiment, the encoder is configured to do the following:

```
int totpixels = 0;
double totsse = 0.0;
double one_over_gamma = 1.0/2.20;
for c = −34 to 15
  two_to_stopval = exp(1.0*c*log(2.0));
  for each pixel x,y
        LDR_orig[(y*width+x)*3+0] = JAS_ROUND(CLAMP(0, 255.0*exp( one_over_gamma * log(
((1.0 * (two_to_stopval))*mypixels_orig[(y*width+x)*3+0]) ) ), 255));
        LDR_orig[(y*width+x)*3+1] = JAS_ROUND(CLAMP(0, 255.0*exp( one_over_gamma * log(
((1.0 * (two_to_stopval))*mypixels_orig[(y*width+x)*3+1]) ) ), 255));
        LDR_orig[(y*width+x)*3+2] = JAS_ROUND(CLAMP(0, 255.0*exp( one_over_gamma * log(
((1.0 * (two_to_stopval))*mypixels_orig[(y*width+x)*3+2]) ) ), 255));
        LDR_copy[(y*width+x)*3+0] = JAS_ROUND(CLAMP(0, 255.0*exp( one_over_gamma * log(
((1.0 * (two_to_stopval))*mypixels_copy[(y*width+x)*3+0]) ) ), 255));
        LDR_copy[(y*width+x)*3+1] = JAS_ROUND(CLAMP(0, 255.0*exp( one_over_gamma * log(
((1.0 * (two_to_stopval))*mypixels_copy[(y*width+x)*3+1]) ) ), 255));
        LDR_copy[(y*width+x)*3+2] = JAS_ROUND(CLAMP(0, 255.0*exp( one_over_gamma * log(
((1.0 * (two_to_stopval))*mypixels_copy[(y*width+x)*3+2]) ) ), 255));
        if(LDR_orig[y*width*3+x*3+0]==0  &&  LDR_orig[y*width*3+x*3+1]==0  &&
LDR_orig[y*width*3+x*3+2]==0)
          continue;
        if(LDR_orig[y*width*3+x*3+0]==255  ||  LDR_orig[y*width*3+x*3+1]==255  ||
LDR_orig[y*width*3+x*3+2]==255)
          continue;
        c_err = (1.0*LDR_copy[y*width*3+x*3+0]−1.0*LDR_orig[y*width*3+x*3+0]);
        err = c_err*c_err;
        c_err = (1.0*LDR_copy[y*width*3+x*3+1]−1.0*LDR_orig[y*width*3+x*3+1]);
        err += c_err*c_err;
        c_err = (1.0*LDR_copy[y*width*3+x*3+2]−1.0*LDR_orig[y*width*3+x*3+2]);
        err += c_err*c_err;
        totsse = totsse + (1.0/3.0)*err;
        totpixels = totpixels + 1;
  end;
end;
MSE = totsse/(1.0*totpixels);
mPSNR = 10*log((1.0*255*255)/MSE)/log(10.0);
```

This can be done for an entire image, or for all pixels in an entire video sequence, or all pixels in an area such as a block etc.

There are also faster ways to calculate this. You can look for the largest component, (for instance 4000 in the color (12, 4000, 3905)) and calculate the smallest c-value that will pass the blackness criterion, and the largest c-value that will pass the “saturation to 255”-criterion. Then you can sum the error only over those. This is faster than the above code since it will demand only about 20 calculations instead of 50 (−34 to 15), and it is also faster since you do not have to do any if-statements inside the loop. However the above code is easier to read.

The function

R_{LDR}^{c}(x, y)=clamp(0,255, round(255*(2^{c}*R_{HDR}(x, y))^{(1/γ)}))

G_{LDR}^{c}(x, y)=clamp(0,255, round(255*(2^{c}*G_{HDR}(x, y))^{(1/γ)}))

B_{LDR}^{c}(x, y)=clamp(0,255, round(255*(2^{c}*B_{HDR}(x, y))^{(1/γ)}))

is an example of a so called “tone mapping” operation. Other tone mappers are possible, for instance

$$PQ ( x ) = {( \frac{{c}_{2} * {x}^{{m}_{1}} + {c}_{1}}{{c}_{3} * {x}^{{m}_{1}} + 1} )}^{{m}_{2}}$$

$$where \text{:}$$

$${m}_{1} = \frac{2610}{4 * 4096}$$

$${m}_{2} = \frac{2523 * 128}{4096}$$

$${c}_{1} = \frac{3424}{4096}$$

$${c}_{2} = \frac{2413 * 32}{4096}$$

$${c}_{3} = \frac{2392 * 32}{4096}$$

The mapping could be performed now using the formulation:

R_{LDR}^{c}(x, y)=clip(0, 2^{N}−1, floor((2^{N}−1)*PQ(2^{c}*R_{HDR}(x, y))))

G_{LDR}^{c}(x, y)=clip(0, 2^{N}−1, floor((2^{N}−1)*PQ(2^{c}*G_{HDR}(x, y))))

B_{LDR}^{c}(x, y)=clip(0, 2^{N}−1, floor((2^{N}−1)*PQ(2^{c}*R_{HDR}(x, y))))

A novel aspect is in investigating only those pixels which differ from (0,0,0) and (x, y, 255), (x, 255, y) and (255, x, y).

It is also possible with other criteria, for instance
exclude only those pixels that are either (0,0,0) or (255, 255, 255);
exclude only those pixels that contain at least one zero or one at least one 255; or
exclude only those pixels that contain at least one zero or are equal to (255, 255, 255).

The method and the encoder of the embodiments are applicable for coding of high dynamic range material and evaluation of high dynamic range material.

The virtual photographs, i.e. tone mapped versions, are created using the following simple tone mapping operator of both the original image and the compressed HDR image (reconstructed image):

R_{LDR}^{c}(x, y)=clamp(0,255, round(255*(2^{c}*R_{HDR}(x, y))^{(1/γ)}))

G_{LDR}^{c}(x, y)=clamp(0,255, round(255*(2^{c}*G_{HDR}(x, y))^{(1/γ)}))

B_{LDR}^{c}(x, y)=clamp(0,255, round(255*(2^{c}*B_{HDR}(x, y))^{(1/γ)}))

where c is the exposure compensation in f-stops, γ equals 2.2 and clamp(a, b, t) clamps t to the interval [a, b]. Next, the mean square error of a compressed HDR image is calculated over all the virtual photographs relative to the original HDR image using

$$MSE = \frac{1}{n \times W \times H} {\sum }_{c}^{ } {\sum }_{x , y}^{ } \frac{1}{3} \{ {( Δ {R}_{LDR}^{c} )}^{2} + {( Δ {G}_{LDR}^{c} )}^{2} + {( Δ {B}_{LDR}^{c} )}^{2} \} ,$$

where n is the number of virtual photographs and Wand H are the width and height of the image and Δ represents the difference between the value in the virtual photograph of the compressed image and the virtual photograph of the original image. In the original paper [2], the range for c was selected by hand so that the smallest c would produce a virtual photograph that was not too dark, and the largest c would produce a virtual photograph that was not too bright.

Whereas this strategy works well for still images, it is not feasible to select a range for c for each frame in a video sequence by hand. Therefore, in this document, we propose to use a fixed range of c that is wide enough to guarantee that the entire signal is covered. For instance, OpenEXR is a high dynamic range imaging image file format (.exr file). It is notable for supporting 16-bit-per-channel floating point values (half precision), with a sign bit, five bits of exponent, and a ten-bit significand. Thus, since the largest value in a 16-bit .exr file is 65504, using c=−34 will map 65504 to 1, in other words, the virtual photograph produced is almost completely black. Setting the largest c-value to 16 will give a virtual photograph that is almost completely white.

This brings another problem. For low c values, most pixels will be completely black, (0,0,0). The error in these pixels will therefore most likely be zero, and the corresponding PSNR value for that virtual photograph will be very high. Likewise in the other end, most pixels will be completely white (255, 255, 255), which will also wrongly affect the PSNR value.

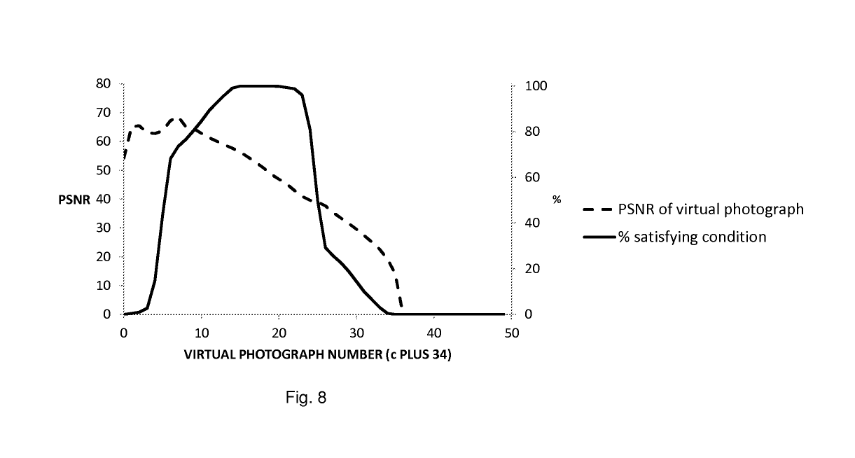

Therefore we have adapted the mPSNR value so that the error is only counted over pixels that satisfy the following two conditions: 1) the pixel in the virtual photograph of the original must not be black (0,0,0), and 2) the pixel in the virtual photograph of the original must not have any of the color channels saturated meaning that none of the components should be 255, such as (54, 255, 18). The MSE formula is thus changed to

$$MSE = \frac{1}{{Σ}_{c} ‖ {S}_{c} ‖} {\sum }_{c}^{ } {\sum }_{{S}_{c}}^{ } \frac{1}{3} \{ {( Δ {R}_{LDR}^{c} )}^{2} + {( Δ {G}_{LDR}^{c} )}^{2} + {( Δ {B}_{LDR}^{c} )}^{2} \} ,$$

where S_{c} is the set of pixels that satisfies both conditions for virtual photograph c, and ∥S_{c}∥ is the number of such pixels in virtual photograph c. This has two implications. First, it will exclude black pixels from affecting the MSE. In FIG. 8, it can be seen that the contribution of the darkest virtual photographs to the measure will be practically zero.

The second effect is that it will exclude saturated pixels. As an example, assume the true RGB is (4000, 3, 1), and after compression and decompression you get (3950, 1, 1). This representation should be quite satisfactory, since it gets the color and luminance roughly right (very red and bright). However, with c=−3 the original would become (255, 163, 99) and the compressed would become (255, 99, 99), which would generate a huge error in the green component. The criterion that no channel may be saturated will remove these pixels from the calculation. It will also make sure that the contribution to the mPSNR from virtual photographs associated with very high c values tapers off, since these mostly will consist of pixels with at least one saturated color. This is also visible in FIG. 8, where the solid line tapers off to the right in the diagram.

Finally, the mPSNR value for the image or frame is calculated as

$$mPSNR = 10 {log}_{10} ( \frac{{255}^{2}}{MSE} ) ,$$

and the individual mPSNR values for each image or frame can then be averaged to provide an aggregate mPSNR value for the entire sequence. Or alternatively, the MSE value will be calculated for the entire sequence, and then that number is fed through the above formula to get an mPSNR number.

It should be noted that in the above described examples we have stayed as close as possible to the formulation in [2]. For instance, the mPSNR value is calculated for R, G, B rather than Y, Cb and Cr as is typical in SDR video compression. It is of course possible to change from R, G, B to Y, Cb and Cr or to another luminance+chrominance color space right before calculating the MSE, if one would prefer a measure that is more similar to previous ones.

It is also possible to include pixels that are close to 255 but strictly bigger than 255, for instance by setting the limit (saturation value) to 384 instead, but still clamping to [0, 255]. This would make the measure be more sensitive to errors in components that are much smaller than the largest component, such as in the example of a very bright red color (4000, 3, 1). However, due to the gamma curve, there is already an increased sensitivity to the smaller components; the highest c value for a pixel (4000, 3, 1) would be c=−12 which would map to (252, 10, 6), so even in this rather extreme example the relative error in the weakest color component is at most 1/6. Thus an alternative could be to use a stronger gamma than 2.2

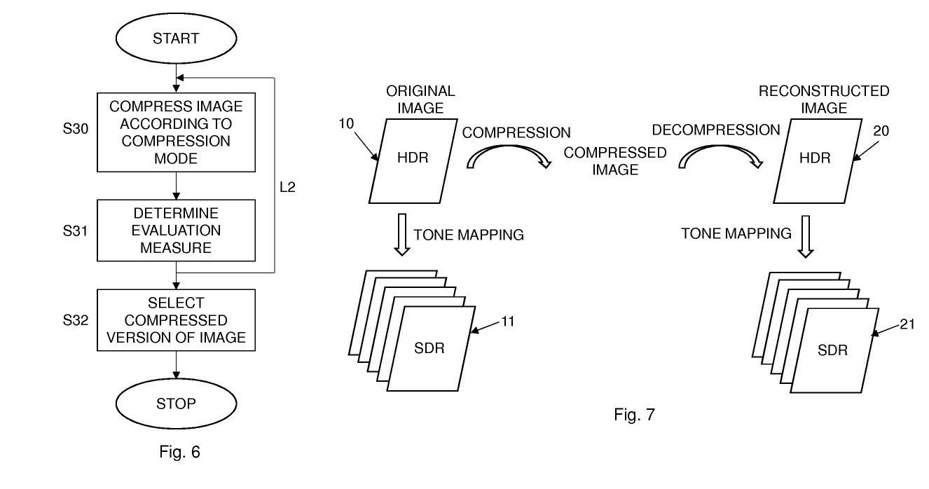

FIG. 6 is a flow chart illustrating an image encoding method according to an embodiment. The method comprises compressing at least a portion of an image according to multiple compression modes to obtain multiple compressed versions of the at least a portion of the image. The following step S31 comprises determining, for each compression mode of the multiple compression modes, a respective evaluation measure for the image according to the embodiments. A next step S32 comprises selecting a compressed version of the at least a portion of the image as an encoded presentation of the at least a portion of the image based on the multiple evaluation measures.

In the method as shown in FIG. 6 a complete image is compressed or encoded or a portion of the image is compressed or encoded. This portion could, for instance, correspond to a slice of the image or indeed a block of pixels in the image. Generally, an image or a portion thereof can be compressed or encoded according to multiple compression or encoding modes. For instance, in video coding according to H.264 and H.265 (HEVC) an image, also referred to as frame or picture, could be encoded as an intra image according to one of multiple intra prediction modes or as an inter image according to various inter prediction modes. In such a case, steps S30 and S31 are performed for each such compression or encoding mode, which is schematically represented by the line L2 in FIG. 6.

This means that an original image 10 or a portion thereof is compressed or encoded according to a first compression or encoding mode in step S30 to get a compressed image. This compressed image is then decompressed or decoded according to corresponding decompression or decoding mode to get a reconstructed image 20. Multiple tone mapped versions 11, 21 are then created of the original image 10 and the reconstructed image 20 as previously described herein and an evaluation measure is calculated for the given original image—reconstructed image pair, i.e. for the current compression or encoding mode.

This procedure is then performed for the other available compression or encoding modes giving a respective reconstructed image 20. Please note that in the different compression or encoding modes the original image 10 and the tone mapped versions 11 of the original image 10 are all the same and thereby do not need to be calculated for each compression or encoding mode to be tested. Hence, only the tone mapped versions 21 of the reconstructed images 20 need to be calculated for the second and following compression or encoding modes. The compression in step S30 and the determination in step S31 can be performed at least partly in parallel for the different compression modes in order to speed up the calculations.

Each tested compression or encoding mode will thereby result in a respective evaluation measure as determined in step S31 and as described herein. The different evaluation measures are then compared in step S32 in order to select one the compressed versions of the image 10 or the portion thereof as encoded representation of the original image 10.

In a particular embodiment, step S32 comprises selecting, as the encoded representation of the at least a portion of the image 10, a compressed version of the at least a portion of the image 10 having a highest evaluation measure among the multiple compressed versions of the at least a portion of the image 10.

Thus, the compressed version of the at least a portion of the image 10 obtained using the compression or encoding mode resulting in the highest or largest evaluation measure is thereby selected and used as encoded representation of the at least a portion of the image 10.

The evaluation measure of the embodiments can thereby be used during compression and encoding of various types of images, in particular HDR images, including, but not limited, to still images in graphics and images or pictures of a video sequence, in particular HDR video sequence.

Another aspect of the embodiments relates to an encoder for determining an evaluation measure for an image. The encoder is configured to create, for each tone mapper setting value among a set of multiple tone mapper setting values, a tone mapped version of the image. Each tone mapper setting value represents a respective shutter speed. The encoder is also configured to create, for each tone mapper setting value among the set of multiple tone mapper setting values, a tone mapped version of a version of the image obtained following compression of the image. The encoder is further configured to calculate, for each tone mapper setting value among the set of multiple tone mapper setting values, an error over a non-excluded subset of pixels in the tone mapped version of the image and the tone mapped version of the version of the image obtained following compression of the image. The non-excluded subset of pixels does not meet at least one exclusion criterion. The encoder is additionally configured to calculate a mean squared error as an average error for the respective non-excluded subset of pixels in the multiple tone mapped versions of the image and the multiple tone mapped versions of the version of the image obtained following compression of the image. The encoder is also configured to calculate the evaluation measure based on the mean squared error.

In an embodiment, the encoder is configured to calculate a tone mapped version of the image as:

R_{LDR}^{c}(x, y)=clamp(0, T, round(T×(2^{c}×R_{HDR}(x, y))^{(1/γ)}))

G_{LDR}^{c}(x, y)=clamp(0, T, round(T×(2^{c}×G_{HDR}(x, y))^{(1/γ)}))

B_{LDR}^{c}(x, y)=clamp(0, T, round(T×(2^{c}×B_{HDR}(x, y))^{(1/γ)}))

wherein R_{HDR}(_{x,} y), G_{HDR}(x, y), B_{HDR}(x, y) represent a first, a second and a third pixel component of pixel position (x, y) in the image, R_{LDR}^{C}(x, y), G_{LDR}^{C}(x, y), B_{LDR}(x, y) represent a first, a second and a third pixel component of pixel position (x, y) in the tone mapped version of the image, c represents the tone mapper setting value, γ represents a display gamma, T is a saturation value, clamp(0, T , a) is a clamping function outputting 0 if a<0, T if a>T and a if 0≦a≦T, and round( ) is a rounding function. The encoder is also configured to calculate a tone mapped version of the version of the image obtained following compression of the image as:

R_{LDR,C}^{c}(x, y)=clamp(0, T, round(T×(2^{c}×R_{HDR,C}(x, y))^{(1/γ)}))

G_{LDR,C}^{c}(x, y)=clamp(0, T, round(T×(2^{c}×G_{HDR,C}(x, y))^{(1/γ)}))

B_{LDR,C}^{c}(x, y)=clamp(0, T, round(T×(2^{c}×B_{HDR,C}(x, y))^{(1/γ)}))

wherein R_{HDR,C}(x, y), G_{HDR,C}(x, y), B_{HDR,C}(x, y) represent a first, a second and a third pixel component of pixel position (x, y) in the version of the image obtained following compression of the image, and R_{LDR,C}^{C}(x, y), G_{LDR,C}^{C}(x, y), B_{LDR,C}^{C}(x, y) represent a first, a second and a third pixel component of pixel position (x, y) in the tone mapped version of the version of the image obtained following compression of the image.

In an embodiment, the encoder is configured to calculate the error representing a difference in pixel values of the tone mapped version of the image and the tone mapped version of the version of the image obtained following compression of the image for the non-excluded subset of pixels.

In an embodiment, the at least one exclusion criterion comprises a black pixel and a pixel having at least one pixel component equal to or exceeding a saturation value.

In an embodiment, the encoder is configured to calculate a difference in pixel value of the tone mapped version of the image and the tone mapped version of the version of the image obtained following compression of the image for each pixel position except for pixel positions having a black pixel or having at least one pixel component equal to or exceeding a saturation value in the tone mapped version of the image.

In an embodiment, the encoder is configured to identify a largest component value V of the image. The encoder is also, in this embodiment, configured to select a smallest integer value cₘᵢₙ of the tone mapper setting in the set of multiple tone mapper setting values so that 2^{c}×V^{(1/γ)}>0 and select a largest integer value cₘₐₓ of the tone mapper setting in the set of multiple tone mapper setting values so that 2^{c}×V^{(1/γ)}<T. T is a saturation value and the set of multiple tone mapper setting values is [cₘᵢₙ, cₘₐₓ].

In an embodiment, the encoder is configured to calculate the mean squared error as:

$$MSE = \frac{1}{{Σ}_{c} ‖ {S}_{c} ‖} {\sum }_{c}^{ } {\sum }_{{S}_{c}}^{ } \frac{1}{3} ( {( Δ {R}^{c} )}^{2} + {( Δ {G}^{c} )}^{2} + {( Δ {B}^{c} )}^{2} )$$

wherein S_{c}. represents the non-excluded subset of pixels for the tone mapper setting value c, ∥S_{c}∥ represents the number of pixels in the non-excluded subset of pixels for the tone mapper setting value c, ΔR^{c}=R_{LDR}^{c}−R_{LDR,C}^{c}, ΔG^{c}=G_{LDR}^{c}−G_{LDR,C}^{c}, ΔB^{c}=B_{LDR}^{c}−B_{LDR,C}^{c}, R_{LDR}^{C}(x, y), G_{LDR}^{C}(x, y), B_{LDR}^{c}(x, y) represent a first, a second and a third pixel component of pixel position (x, y) in the tone mapped version of the image, and R_{LDR,C}^{C}(x, y), G_{LDR,C}^{C}(x, y), B_{LDR,C}^{c}(x, y) represent a first, a second and a third pixel component of pixel position (x, y) in the tone mapped version of the version of the image obtained following compression of the image.

In an embodiment, the encoder is configured to calculate the evaluation measure as a peak signal-to-noise ratio of the mean squared error.

In an embodiment, the encoder is configured to calculate the peak signal-to-noise ratio as:

$$mPSNR = 10 \times {log}_{10} ( \frac{{T}^{2}}{MSE} )$$

wherein MSE represents the mean squared error and T represents a saturation value.

According to a further aspect of the embodiments, an encoder 110 for encoding a video sequence is provided. The encoder 110 comprises processing means 113, see FIG. 11, operative to:
create a tone mapped version of the original and the compressed image (reconstructed image);
exclude some pixels due to an exclusion criterion;
calculate the error over the non-excluded pixels;
do this over a variety of tone mapper settings from dark to bright;
calculate the MSE as the average error for these non-excluded pixels in all these tone mapped images; and
calculate the PSNR from this MSE.

The processing means 113 may comprise a processor 111 and a memory 112 wherein the memory 112 is containing instructions executable by the processor 111.

It will be appreciated that the methods and devices described herein can be combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Particular examples include one or more suitably configured digital signal processors and other known electronic circuits, e.g. discrete logic gates interconnected to perform a specialized function, or Application Specific Integrated Circuits (ASICs).

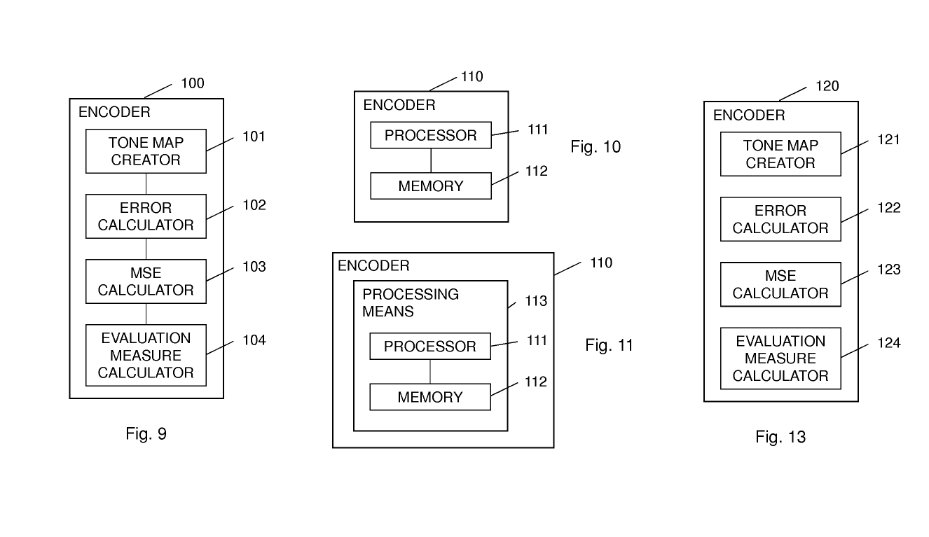

FIG. 9 illustrates a particular hardware implementation of the encoder 100. In an embodiment, the encoder 100 comprises a tone map creator 101 configured to create the tone mapped versions of the image and the tone of mapped versions of the version of the image obtained following compression of the image. The encoder 100 also comprises an error calculator 102 configured to calculate the error over the respective non-excluded subset of pixels in the tone mapped versions of the image and the tone mapped versions of the version of the image obtained following compression of the image. The encoder 100 further comprises a mean squared error (MSE) calculator 103 configured to calculate the mean squared error as the average error and an evaluation measure calculator 104 configured to calculate the evaluation measure based on the mean squared error.

The tone map creator 101 is preferably connected to the error calculator 102 in order to forward the calculated tone mapped versions thereto. The error calculator 102 preferably outputs the calculated errors to the connected MSE calculator 103. The MSE calculator 103 is in turn preferably connected to the evaluation measure calculator 104 in order to provide the calculated mean squared error thereto. Alternatively, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors (DSPs), one or more Central Processing Units (CPUs), video acceleration hardware, and/or any suitable programmable logic circuitry such as one or more Field Programmable Gate Arrays (FPGAs), or one or more Programmable Logic Controllers (PLCs).

It should also be understood that it may be possible to re-use the general processing capabilities of any conventional device, unit, system or arrangement in which the proposed technology is implemented. It may also be possible to re-use existing software, e.g. by reprogramming of the existing software or by adding new software components.

In a particular example, the encoder 110, see FIG. 10, comprises a processor 111 and a memory 112 comprising instructions executable by the processor 111. The processor 111 is operative to create the tone mapped versions of the image and the tone mapped versions of the version of the image obtained following compression of the image. The processor 111 is also operative to calculate the error over the respective non-excluded subset of pixels in the tone mapped versions of the image of the tone mapped versions of the version of the image obtained following compression of the image. The processor 111 is further operative to calculate the mean squared error as an average error and calculate the evaluation measure based on the mean squared error.

In a particular embodiment, the processor 111 is operative, when executing the instructions stored in the memory 112, to perform the above described operations. The processor 111 is thereby interconnected to the memory 112 to enable normal software execution.

FIG. 12 is, in an embodiment, a schematic block diagram illustrating an example of a user equipment 200 comprising a processor 210, an associated memory 220 and a communication circuitry 230.

In this particular example, at least some of the steps, functions, procedures, modules and/or blocks described herein are implemented in a computer program 240, which is loaded into the memory 220 for execution by processing circuitry including one or more processors 210. The processor 210 and memory 220 are interconnected to each other to enable normal software execution. A communication circuitry 230 is also interconnected to the processor 210 and/or the memory 220 to enable input of original HDR images and output of compressed or encoded HDR images.

The term ‘processor’ should be interpreted in a general sense as any system or device capable of executing program code or computer program instructions to perform a particular processing, determining or computing task.

The processing circuitry including one or more processors is thus configured to perform, when executing the computer program, well-defined processing tasks such as those described herein.

The processing circuitry does not have to be dedicated to only execute the above-described steps, functions, procedure and/or blocks, but may also execute other tasks.

In an embodiment, the computer program 240 comprises instructions, which when executed by the processor 210, cause the processor 210 to create, for each tone mapper setting value representing among a set of multiple tone mapper setting values, a tone mapped version of the image and a tone mapped version of a version of the image obtained following compression of the image. Each tone mapper setting value represents a respective shutter speed. The processor 210 is also caused to calculate, for each tone mapper setting value among the set of multiple tone mapper setting values, an error over a non-excluded subset of pixels in the tone mapped version of the image and the tone mapped version of the version of the image obtained following compression of the image. The non-excluded subset of pixels does not meet at least one exclusion criterion. The processor 210 is further configured to calculate a mean squared error as an average error for the respective non-excluded subset of pixels in the multiple tone mapped versions of the image and the multiple tone mapped versions of the version of the image obtained following compression of image. The processor 210 is additionally configured to calculate the evaluation measure based on the mean squared error.

The proposed technology also provides a carrier 250 comprising the computer program 240. The carrier 250 is one of an electronic signal, an optical signal, an electromagnetic signal, a magnetic signal, an electric signal, a radio signal, a microwave signal, or a computer-readable storage medium 250.

By way of example, the software or computer program 240 may be realized as a computer program product, which is normally carried or stored on a computer-readable medium 250, preferably non-volatile computer-readable storage medium 250. The computer-readable medium 250 may include one or more removable or non-removable memory devices including, but not limited to a Read-Only Memory (ROM), a Random Access Memory (RAM), a Compact Disc (CD), a Digital Versatile Disc (DVD), a Blue-ray disc, a Universal Serial Bus (USB) memory, a Hard Disk Drive (HDD) storage device, a flash memory, a magnetic tape, or any other conventional memory device. The computer program 240 may thus be loaded into the operating memory 220 of a computer or equivalent processing device, represented by the user equipment 200 in FIG. 12, for execution by the processor 210 thereof.

The flow diagram or diagrams presented herein may therefore be regarded as a computer flow diagram or diagrams, when performed by one or more processors. A corresponding encoder may be defined as a group of function modules, where each step performed by the processor corresponds to a function module. In this case, the function modules are implemented as a computer program running on the processor. Hence, the encoder may alternatively be defined as a group of function modules, where the function modules are implemented as a computer program running on at least one processor.

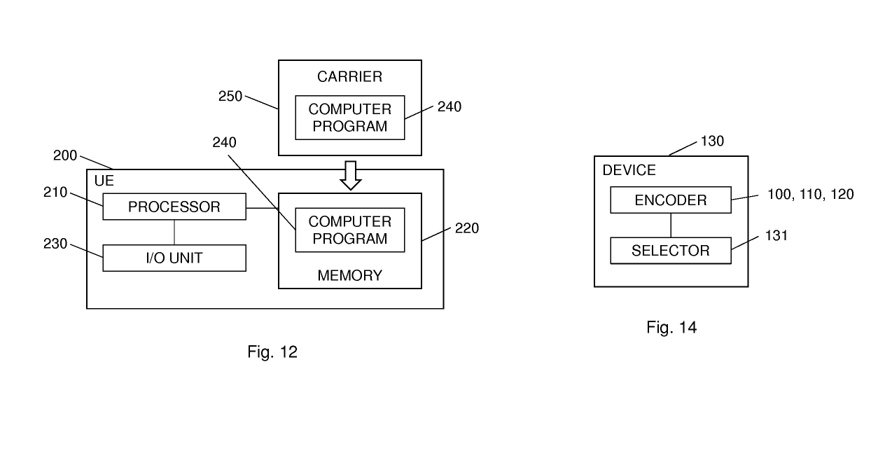

The computer program residing in memory may thus be organized as appropriate function modules configured to perform, when executed by the processor, at least part of the steps and/or tasks described herein. An example of such function modules is illustrated in FIG. 13 illustrating a schematic block diagram of an encoder 120 for determining an evaluation measure for an image with function modules. The encoder 120 comprises a tone map creator 121 for creating, for each tone mapper setting value among a set of multiple tone mapper setting values, a tone mapped version of the image and a tone mapped version of a version of the image obtained following compression of the image. Each tone mapper setting value represents a respective shutter speed. The encoder 120 also comprises an error calculator 122 for calculating, for each tone mapper setting value among the set of multiple tone mapper setting values, an error over a non-excluded subset of pixels in the tone mapped version of the image and the tone mapped version of the version of the image obtained following compression of the image. The non-excluded subset of pixels does not meet at least one exclusion criterion. The encoder 120 also comprises a mean squared error calculator 123 for calculating a mean squared error as an average error for the respective non-excluded subset of pixels in the multiple tone mapped versions of the image and the tone mapped versions of the version of the image obtained following compression of the image. The encoder 120 additionally comprises an evaluation measure calculator 124 for calculation the evaluation measure based on the mean squared error.

The encoder of the embodiments can be implemented in a video camera of a user device or other user device or equipment capable of compressing or encoding images, including video sequences.

A further aspect of the embodiments relates to an image encoding device 130 as shown in FIG. 14. The image encoding device 130 comprises an encoder 100, 110, 120 of the embodiments as described above and disclosed in any of FIGS. 9-11, 13. The encoder 100, 110, 120 is configured to compress at least a portion of an image according to multiple compression modes to obtain multiple compressed versions of the at least a portion of the image and determine, for each compression mode of the multiple compression modes, a respective evaluation measure for the image. The image encoding device 130 also comprises a selector 131 configured to select a compressed version of the at least a portion of the image as an encoded representation of the at least a portion of image based on multiple evaluation measures.

In an embodiment, the selector 131 is configured to select, as the encoded representation of the at least a portion of the image, a compressed version of the image having a highest evaluation measure among the multiple compressed versions of the at least a portion of image.

The selector 131 could be implemented by a processor together with the other functions of the encoder 110 as shown in FIG. 10, a hardware element as shown in FIG. 9 or as a functional module as shown in FIG. 13.

The image encoding device 130 may furthermore be implemented as a computer program comprising instructions executable by a processor.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

### REFERENCES

[1] Francois et al., “Evaluation of distortion metrics on HDR video content”, Joint Collaborative Team on Video Coding (JCT-VC) of ITU-T SG 16 WP 3 and ISO/IEC JTC 1/SC 29/WG 11, 17^{th} Meeting: Valencia, E S, 27 Mar.-4 Apr. 2014, Document: JCTVC-Q0190 (M33077)
[2] Munkberg et al., “High dynamic range texture compression for graphics hardware”, ACM Transactions on Graphics (Proceedings of AM SIGGRAPH 2006, vol. 25, no. 3, 2006

1-28. (canceled)

29. A method for determining an evaluation measure for an image, the method comprising:
performing, for each tone mapper setting value among a set of multiple tone mapper setting values, each tone mapper setting value representing a respective shutter speed, the steps of:
creating a tone mapped version of said image;
creating a tone mapped version of a version of said image obtained following compression of said image; and
calculating an error over a non-excluded subset of pixels in said tone mapped version of said image and in said tone mapped version of said version of said image obtained following compression of said image, said non-excluded subset of pixels does not meet at least one exclusion criterion;
calculating a mean squared error as an average error for said respective non-excluded subset of pixels in said multiple tone mapped versions of said image and said multiple tone mapped versions of said version of said image obtained following compression of said image; and
calculating said evaluation measure based on said mean squared error.

30. The method of claim 29, wherein
creating said tone mapped version comprises calculating a tone mapped version of said image as:
R_{LDR}^{c}(x, y)=clamp(0, T, round (T×(2^{c}×R_{HDR}(x, y))^{(1/γ)}))
G_{LDR}^{c}(x, y)=clamp(0, T, round (T×(2^{c}×G_{HDR}(x, y))^{(1/γ)}))
B_{LDR}^{c}(x, y)=clamp(0, T, round (T×(2^{c}×B_{HDR}(x, y))^{(1/γ)}))
wherein R_{HDR}(x, y), G_{HDR}(x, y), B_{HDR}(x, y) represent a first, a second and a third pixel component of pixel position (x, y) in said image,
R_{LDR}^{C}(x, y), G_{LDR}^{C}(x, y), B_{LDR}^{c}(x, y) represent a first, a second and a third pixel component of pixel position (x, y) in said tone mapped version of said image, c represents said tone mapper setting value, γ represents a display gamma, T is a saturation value, clamp(0, T , a) is a clamping function outputting 0 if a<0, T if a>T and a if 0<a≦T, and round( ) is a rounding function; and
creating said tone mapped version comprises calculating a tone mapped version of said version of said image obtained following compression of said image as:
R_{LDR,C}^{c}(x, y)=clamp(0, T, round (T×(2^{c}×R_{HDR,C}(x, y))^{(1/γ)}))
G_{LDR,C}^{c}(x, y)=clamp(0, T, round (T×(2^{c}×G_{HDR,C}(x, y))^{(1/γ)}))
B_{LDR,C}^{c}(x, y)=clamp(0, T, round (T×(2^{c}×B_{HDR,C}(x, y))^{(1/γ)}))
wherein R_{HDR,C}(x, y), G_{HDR,C}(x, y), B_{HDR,C}(x, y) represent a first, a second and a third pixel component of pixel position (x, y) in said version of said image obtained following compression of said image, and R_{LDR,C}^{C}(x, y), G_{LDR,C}^{C}(x, y), B_{LDR,C}^{c}(x, y) represent a first, a second and a third pixel component of pixel position (x, y) in said tone mapped version of said version of said image obtained following compression of said image.

31. The method of claim 29, wherein calculating said error comprises calculating said error representing a difference in pixel values of said tone mapped version of said image and said tone mapped version of said version of said image obtained following compression of said image for said non-excluded subset of pixels.

32. The method of claim 29, wherein said at least one exclusion criterion comprises:
a black pixel; and
a pixel having at least one pixel component equal to or exceeding a saturation value.

33. The method of claim 32, wherein calculating said error comprises calculating a difference in pixel value of said tone mapped version of said image and said tone mapped version of said version of said image obtained following compression of said image for each pixel position except for pixel positions having a black pixel or having at least one pixel component equal to or exceeding a saturation value in said tone mapped version of said image.

34. The method of claim 29, wherein said set of multiple tone mapper setting values is [−36, 15].

35. The method of claim 29, further comprising:
identifying a largest component value V of said image;
selecting a smallest integer value cₘᵢₙ of said tone mapper setting in said set of multiple tone mapper setting values so that 2^{c}×V^{(1/γ)}>0; and
selecting a largest integer value cₘₐₓ of said tone mapper setting in said set of multiple tone mapper setting values so that 2^{c}×V^{(1/γ)}<T, wherein T is a saturation value and said set of multiple tone mapper setting values is [cₘᵢₙ, cₘₐₓ].

36. The method of claim 29, wherein calculating said mean squared error comprises calculating said mean squared error as:
$$MSE = \frac{1}{{Σ}_{c} ‖ {S}_{c} ‖} {\sum }_{c}^{ } {\sum }_{{S}_{c}}^{ } \frac{1}{3} ( {( Δ {R}^{c} )}^{2} + {( Δ {G}^{c} )}^{2} + {( Δ {B}^{c} )}^{2} )$$
wherein S_{c} represents said non-excluded subset of pixels for said tone mapper setting value c, ∥S_{c}∥ represents the number of pixels in said non-excluded subset of pixels for said tone mapper setting value c, ΔR^{c}=R_{LDR}^{c}−R_{LDR,C}^{c}, ΔG^{c}=G_{LDR}^{c}−G_{LDR,C}^{c}, ΔB^{c}=B_{LDR}^{c}−B_{LDR,C}^{c}, R_{LDR}^{C}(x, y), G_{LDR}^{C}(x, y), B_{LDR}^{c}(x, y) represent a first, a second and a third pixel component of pixel position (x, y) in said tone mapped version of said image, and
R_{LDR,C}^{C}(x, y), G_{LDR,C}^{C}(x, y), B_{LDR,C}^{c}(x, y) represent a first, a second and a third pixel component of pixel position (x, y) in said tone mapped version of said version of said image obtained following compression of said image.

37. The method of claim 29, wherein calculating said evaluation measure comprises calculating said evaluation measure as a peak signal-to-noise ratio of said mean squared error.

38. The method of claim 37, wherein calculating said peak signal-to-noise ratio comprises calculating said peak signal-to-noise ratio as:
$$mPSNR = 10 \times {log}_{10} ( \frac{{T}^{2}}{MSE} )$$
wherein MSE represents said mean squared error and T represents a saturation value.

39. An image encoding method comprising:
compressing at least a portion of an image according to multiple compression modes to obtain multiple compressed versions of said at least a portion of said image;
determining, for each compression mode of said multiple compression modes, a respective evaluation measure for said image; and
selecting a compressed version of said at least a portion of said image as an encoded representation of said at least a portion of said image based on said multiple evaluation measures;
wherein said determining of the respective evaluation for said image comprises:
performing, for each tone mapper setting value among a set of multiple tone mapper setting values, each tone mapper setting value representing a respective shutter speed, the steps of:
creating a tone mapped version of said image;
creating a tone mapped version of a version of said image obtained following compression of said image; and
calculating an error over a non-excluded subset of pixels in said tone mapped version of said image and in said tone mapped version of said version of said image obtained following compression of said image, said non-excluded subset of pixels does not meet at least one exclusion criterion;
calculating a mean squared error as an average error for said respective non-excluded subset of pixels in said multiple tone mapped versions of said image and said multiple tone mapped versions of said version of said image obtained following compression of said image; and
calculating said evaluation measure based on said mean squared error.

40. The method of claim 39, wherein selecting said compressed version comprises selecting, as said encoded representation of said at least a portion of said image, a compressed version of said at least a portion of said image having a highest evaluation measure among said multiple compressed versions of said at least a portion of said image.

41. An encoder for determining an evaluation measure for an image, said encoder comprising processing circuitry configured to:
create, for each tone mapper setting value among a set of multiple tone mapper setting values, each tone mapper setting value represents a respective shutter speed, a tone mapped version of said image;
create, for each tone mapper setting value among said set of multiple tone mapper setting values, a tone mapped version of a version of said image obtained following compression of said image;
calculate, for each tone mapper setting value among said set of multiple tone mapper setting values, an error over a non-excluded subset of pixels in said tone mapped version of said image and said tone mapped version of said version of said image obtained following compression of said image, said non-excluded subset of pixels does not meet at least one exclusion criterion;
calculate a mean squared error as an average error for said respective non-excluded subset of pixels in said multiple tone mapped versions of said image and said multiple tone mapped versions of said version of said image obtained following compression of said image; and
calculate said evaluation measure based on said mean squared error.

42. The encoder of claim 41, wherein the processing circuitry is configured to calculate a tone mapped version of said image as:
R_{LDR}^{c}(x, y)=clamp(0, T, round (T×(2^{c}×R_{HDR}(x, y))^{(1/γ)}))
G_{LDR}^{c}(x, y)=clamp(0, T, round (T×(2^{c}×G_{HDR}(x, y))^{(1/γ)}))
B_{LDR}^{c}(x, y)=clamp(0, T, round (T×(2^{c}×B_{HDR}(x, y))^{(1/γ)}))
wherein R_{HDR}(x, y), G_{HDR}(x, y), B_{HDR}(x, y) represent a first, a second and a third pixel component of pixel position (x, y) in said image,
R_{LDR}^{C}(x, y), G_{LDR}^{C}(x, y), B_{LDR}^{c}(x, y) represent a first, a second and a third pixel component of pixel position (x, y) in said tone mapped version of said image, c represents said tone mapper setting value, γ represents a display gamma, T is a saturation value, clamp(0, T, a) is a clamping function outputting 0 if a<0, T if a>T and a if 0≦a≦T, and round( ) is a rounding function; and
said encoder is configured to calculate a tone mapped version of said version of said image obtained following compression of said image as:
R_{LDR,C}^{c}(x, y)=clamp (0, T, round(T×(2^{c}×R_{HDR,C}(x, y))^{(1/γ)}))
G_{LDR,C}^{c}(x, y)=clamp (0, T, round(T×(2^{c}×G_{HDR,C}(x, y))^{(1/γ)}))
B_{LDR,C}^{c}(x, y)=clamp (0, T, round(T×(2^{c}×B_{HDR,C}(x, y))^{(1/γ)}))
wherein R_{HDR,C}(x, y), G_{HDR,C}(x, y), B_{HDR,C}(x, y) represent a first, a second and a third pixel component of pixel position (x, y) in said version of said image obtained following compression of said image, and R_{LDR,C}^{C}(x, y), G_{LDR,C}^{C}(x, y), B_{LDR,C}^{c}(x, y) represent a first, a second and a third pixel component of pixel position (x, y) in said tone mapped version of said version of said image obtained following compression of said image.

43. The encoder of claim 41, wherein the processing circuitry is configured to calculate said error representing a difference in pixel values of said tone mapped version of said image and said tone mapped version of said version of said image obtained following compression of said image for said non-excluded subset of pixels.

44. The encoder of claim 41, wherein said at least one exclusion criterion comprises:
a black pixel; and
a pixel having at least one pixel component equal to or exceeding a saturation value.

45. The encoder of claim 44, wherein the processing circuitry is configured to calculate a difference in pixel value of said tone mapped version of said image and said tone mapped version of said version of said image obtained following compression of said image for each pixel position except for pixel positions having a black pixel or having at least one pixel component equal to or exceeding a saturation value in said tone mapped version of said image.

46. The encoder of claim 41, wherein
the processing circuitry is configured to identify a largest component value V of said image;
the processing circuitry is configured to select a smallest integer value cₘᵢₙ of said tone mapper setting in said set of multiple tone mapper setting values so that 2^{c}×V^{(1/γ)}>T; and
the processing circuitry is configured to select a largest integer value cₘₐₓ of said tone mapper setting in said set of multiple tone mapper setting values so that 2^{c}×V^{(1/γ)}<T, wherein T is a saturation value and said set of multiple tone mapper setting values is [cₘᵢₙ, cₘₐₓ].

47. The encoder of claim 41, wherein the processing circuitry is configured to calculate said mean squared error as:
$$MSE = \frac{1}{{Σ}_{c} ‖ {S}_{c} ‖} {\sum }_{c}^{ } {\sum }_{{S}_{c}}^{ } \frac{1}{3} ( {( Δ {R}^{c} )}^{2} + {( Δ {G}^{c} )}^{2} + {( Δ {B}^{c} )}^{2} )$$
wherein S_{c} represents said non-excluded subset of pixels for said tone mapper setting value c, ∥S_{c}∥ represents the number of pixels in said non-excluded subset of pixels for said tone mapper setting value c, ΔR^{c}=R_{LDR}^{c}−R_{LDR,C}^{c}, ΔG^{c}=G_{LDR}^{c}−G_{LDR,C}^{c}, ΔB^{c}=B_{LDR}^{c}−B_{LDR,C}^{c}, R_{LDR}^{C}(x, y), G_{LDR}^{C}(x, y), B_{LDR}^{c}(x, y) represent a first, a second and a third pixel component of pixel position (x, y) in said tone mapped version of said image, and
R_{LDR,C}^{C}(x, y), G_{LDR,C}^{C}(x, y), B_{LDR,C}^{c}(x, y) represent a first, a second and a third pixel component of pixel position (x, y) in said tone mapped version of said version of said image obtained following compression of said image.

48. The encoder of claim 41, wherein the processing circuitry is configured to calculate said evaluation measure as a peak signal-to-noise ratio of said mean squared error.

49. The encoder of claim 48, wherein the processing circuitry is configured to calculate said peak signal-to-noise ratio as:
$$mPSNR = 10 \times {log}_{10} ( \frac{{T}^{2}}{MSE} )$$
wherein MSE represents said mean squared error and T represents a saturation value.

50. An encoder for determining an evaluation measure for an image, the encoder comprising processing circuitry configured to:
create, for each tone mapper setting value among a set of multiple tone mapper setting values, each tone mapper setting value represents a respective shutter speed, a tone mapped version of said image and a tone mapped version of a version of said image obtained following compression of said image;
calculating, for each tone mapper setting value among said set of multiple tone mapper setting values, an error over a non-excluded subset of pixels in said tone mapped version of said image and said tone mapped version of said version of said image obtained following compression of said image, said non-excluded subset of pixels does not meet at least one exclusion criterion;
calculate a mean squared error as an average error for said respective non-excluded subset of pixels in said multiple tone mapped versions of said image and said tone mapped versions of said version of said image obtained following compression of said image; and
calculate said evaluation measure based on said mean squared error.

51. An image encoding device comprising processing circuitry configured to:
compress at least a portion of an image according to multiple compression modes to obtain multiple compressed versions of said at least a portion of said image;
determine, for each compression mode of said multiple compression modes, a respective evaluation measure for said image; and
select a compressed version of said at least a portion of said image as an encoded representation of said at least a portion of said image based on said multiple evaluation measures;
wherein the processing circuitry is configured determine the respective evaluation for said image, for each compression mode of said multiple compression modes, by:
performing, for each tone mapper setting value among a set of multiple tone mapper setting values, each tone mapper setting value representing a respective shutter speed, the steps of:
creating a tone mapped version of said image;
creating a tone mapped version of a version of said image obtained following compression of said image; and
calculating an error over a non-excluded subset of pixels in said tone mapped version of said image and in said tone mapped version of said version of said image obtained following compression of said image, said non-excluded subset of pixels does not meet at least one exclusion criterion;
calculating a mean squared error as an average error for said respective non-excluded subset of pixels in said multiple tone mapped versions of said image and said multiple tone mapped versions of said version of said image obtained following compression of said image; and
calculating said evaluation measure based on said mean squared error.

52. The image encoding device of claim 51, wherein said selector is configured to select, as said encoded representation of said at least a portion of said image, a compressed version of said image having a highest evaluation measure among said multiple compressed versions of said at least a portion said image.

53. A non-transitory computer-readable medium comprising computer program instructions stored thereon, which computer program instructions are configured so that, when executed by a processor, the computer program instructions cause said processor to:
create, for each tone mapper setting value representing among a set of multiple tone mapper setting values, each tone mapper setting value represents a respective shutter speed, a tone mapped version of said image and a tone mapped version of a version of said image obtained following compression of said image;
calculate, for each tone mapper setting value among said set of multiple tone mapper setting values, an error over a non-excluded subset of pixels in said tone mapped version of said image and said tone mapped version of said version of said image obtained following compression of said image, said non-excluded subset of pixels does not meet at least one exclusion criterion;
calculate a mean squared error as an average error for said respective non-excluded subset of pixels in said multiple tone mapped versions of said image and said multiple tone mapped versions of said version of said image obtained following compression of said image; and
calculate said evaluation measure based on said mean squared error.
